(19) United States
(12) Patent Application Publication
(10) Pub. No.: US 2009/0007243 A1
(43) Pub. Date: Jan. 1, 2009

(54) METHOD FOR RENDERING PASSWORD THEFT INEFFECTIVE

(75) Inventors: Michael Boodaei, Givatayim (IL); Amit Klein, Hertzliya (IL)

Correspondence Address: MERCHANT & GOULD PC, P.O. BOX 2903, MINNEAPOLIS, MN, 55402-0903, US

(73) Assignee: TRUSTEER LTD., Ramat-Gan (IL)

(21) Appl. No.: 11/769,361

(22) Filed: Jun. 27, 2007

(51) Int. Cl. H04L 9/32

(52) U.S. Cl. 726/5

(57) ABSTRACT

A method for rendering a login theft ineffective includes detecting a submission of a first login request from the user's client to a Web site; redirecting the first login request to the traffic processor for copying at least one of the user supplied login fields; forwarding the first login request from the traffic processor to the site; requesting replacements of at least one of the user supplied login fields from the site; and replacing the at least one of user supplied login fields with at least one new corresponding login field(s) in the site.

### FIELD OF THE INVENTION

The present invention relates to the field of Internet security, secure login, and secure eCommerce. More particularly, the invention relates to a method for preventing exploitation of a stolen password.

### BACKGROUND OF THE INVENTION

A computer executing a browser, referred to hereinafter as a Web Client or client, is essentially a hyper text reader communicating with a Web Server via a specific data transfer protocol such as a Hyper Text Transfer Protocol (HTTP). Any hyper text file on the web is uniquely identified by its Universal Resource Locator (URL). Many of the hyper text files are currently structured using the Hyper Text Mark-up Language (HTML) which may also be used for calling hyper text data objects. The hyper text data object may be in the form of any information medium including a text, an image, a voice, a moving picture or an executable computer program. When a client requests a hyper text file, using the file's URL, the file is displayed on the client's browser, where the display is commonly known as a web page. The client can return data to the server and call a Common Gateway Interface (CGI) program on the server computer to perform a specific task.

In online Internet browsing, many web sites require users to authenticate themselves using a username and a password. The password serves as the secure factor of this authentication scheme. Compromise of the password and the corresponding user name allows an attacker to log in virtually from anywhere in the world. It is therefore a prime target of an attacker to thief, i.e. copy, a user's password. Many techniques were developed by attackers to achieve this goal. Among those techniques are: phishing, man-in-the-middle techniques, key-logging, cross site scripting attacks, attaching to the browser's events, and so forth.

One of the ways to maliciously copy a password is “phishing” where an attempt to fraudulently acquire usernames and passwords is done by masquerading as a trustworthy entity to an unsuspecting user. Phishing is typically carried out using email or an instant message, and often directs users to a fraudulant website requesting the user to submit his user name and password. Until today attempts to deal with the growing number of reported phishing incidents came short of being effective.

Another way to maliciously copy a password is “Cross Site Scripting”. This attack exploits a vulnerability of the targeted web site, which allows the attacker to craft a malicious link (in the target web site) and entice the user to click it. Once the user clicks this link, the attacker's Javascript/VBscript code runs at the user's browser in the context of the web site. This malicious code can eavesdrop to the password, once the user enters it in the web site, and then send the password to the attacker.

Another way to maliciously copy a password is by implementing in the client a “Malicious browser plug-in”. The malicious browser plug-in (e.g. BHO technology in Microsoft Internet Explorer) waits for the user to log in, and then forwards the password to the attacker's server, where it is collected by the attacker and used to browse the web site with the same privileges as the logged in user.

As of today some methods exist for combating password theft:

Additional tokens (hardware or software): these solutions add a “second authentication factor” in the form of the token—which is a piece of hardware/software that generates a one-time (or limited time) token value, of cryptographic strength. Without this unpredictable value, it is impossible to login. Yet it is possible to easily bypass this additional authentication factor with a simple phishing attack that now works online. The attack proceeds as following: an attacker creates a phishing website mimicking the real web site. The attacker lures victims to visit the site, pretending it to be the real website. The victims compromise both the password and the token, and those are used immediately by the phishing website to login to the real website.

Password managers/vaults: password managers rid users from the need to remember passwords and type them. They associate passwords with the sites and pages in which they were originally typed, and when the same page is loaded again in the browser, they automatically fill in the password. Password managers/vaults are typically useless against browser malware which intercepts the password after it was inserted by the password manager/vault but before it was sent by the browser to the site.

Desktop recognition solutions: these solutions tie the authentication process (e.g. submission of username and password) to the desktop, e.g. by sending a desktop-specific cookie. However, these solutions are defeated by malware that steals both the password and the cookie.

PwdHash (http://crypto.stanford.edu/PwdHash/): this solution replaces the plain password typed by the user at the browser, by a one-way hash of the password and the domain name to which the password is submitted. This does not hide the password from an attacker on the machine itself (e.g. key-logger). Even if the user keystrokes are encrypted, the browser has to receive the hashed password and send it to the website. At the point where the browser receives the bashed password, it can be intercepted by malware. With this hashed password, an attacker can log in to the site from any desktop.

It is an object of the present invention to provide a method for rendering password theft ineffective.

It is another object of the present invention to provide a method for preventing an unauthorized user from falsely identifying to a secure web site using a stolen password.

It is still another object of the present invention to provide a method for rendering ineffective the password theft made by Phishing or Malicious browser plug-ins.

Other objects and advantages of the invention will become apparent as the description proceeds.

### SUMMARY OF THE INVENTION

The present invention relates to a method for rendering a login theft ineffective comprising the steps of: (a) detecting a submission of a first login request from the user's client to a Web site; (b) redirecting said first login request to the traffic processor for copying at least one of the user supplied login fields; (c) forwarding said first login request from said traffic processor to said site; (d) requesting replacements of at least one of said user supplied login fields from said site, and (e) replacing said at least one of user supplied login fields with at least one new corresponding login field(s) in said site.

Preferably, the method further comprises the steps of: (a) detecting a second login request intended for the Web site; (b) redirecting said second request to the traffic processor by the redirector; (c) replacing the user supplied login field(s) with the new corresponding login field(s); and (d) forwarding the modified second login request to said site.

Preferably, the user supplied login fields and new corresponding login fields are stored in a table.

Preferably, the forwarding of the request(s) by the traffic processor and the receiving of response(s) from the site is done using a secure path.

Preferably, the user is notified before the user supplied login fields are replaced with new corresponding login fields.

Preferably, permission is requested from the user prior to replacing the user supplied login fields with new corresponding login fields.

In an embodiment, the new corresponding login fields are produced by applying a deterministic function to the original login fields.

In an embodiment, the new corresponding login fields are produced by applying a non-algorithmic function.

Preferably, the user may obtain the new corresponding login fields.

The invention further relates to a method for rendering a login theft ineffective comprising the steps of: (a) detecting a submission of a first login request from a client to a Server; (b) redirecting said first login request to the traffic processor for copying at least one of the user supplied login fields; (c) forwarding said first login request from said traffic processor to said Server; (d) requesting replacements of at least one of said user supplied login fields from said Server; and (e) replacing said at least one of user supplied login fields with at least one new corresponding login field(s) in said Server.

### BRIEF DESCRIPTION OF THE DRAWINGS

In the drawings:

FIG. 1 is a schematic diagram of the system according to one of the embodiments of the invention.

FIG. 2 is a block diagram illustrating the method of the invention according to one of the embodiments.

FIG. 3 is a schematic diagram of the system according to another embodiment of the invention.

### DETAILED DESCRIPTION OF PREFERRED EMBODIMENTS

The term login, or login fields, is referred hereinafter to any one or a combination of user authentication fields such as: username, password, user ID, authentication, authenticating code, user defined input, identifying field, etc.

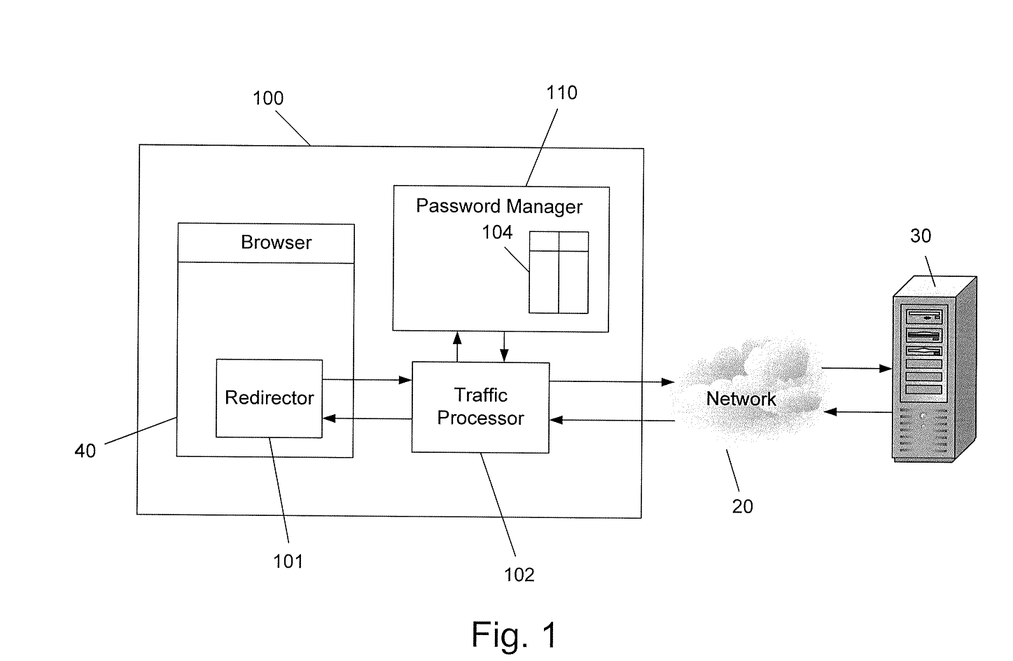

FIG. 1 is a schematic diagram of the system according to one of the embodiments of the invention. In the diagram, client 100 executes a browser 40 when surfing a Network 20 to web server 30. The redirector 101 is installed in browser 40 in order to avert the communication into Traffic Processor 102, installed on the client 100, when the browser 40 communicates with a protected site. The Traffic Processor 102 purpose is to monitor the flow of data between the browser 40 and the protected site on web server 30 for detecting a transmittal of the login request. Once Traffic Processor 102 detects a transmittal of the login request it extracts the login fields and sends them to Password Manager 110. The Password Manager 110 purpose is to provide a replacement to some or all of the login fields. In one of the embodiments the login fields and their replacements are stored in table 104 for later retrieval.

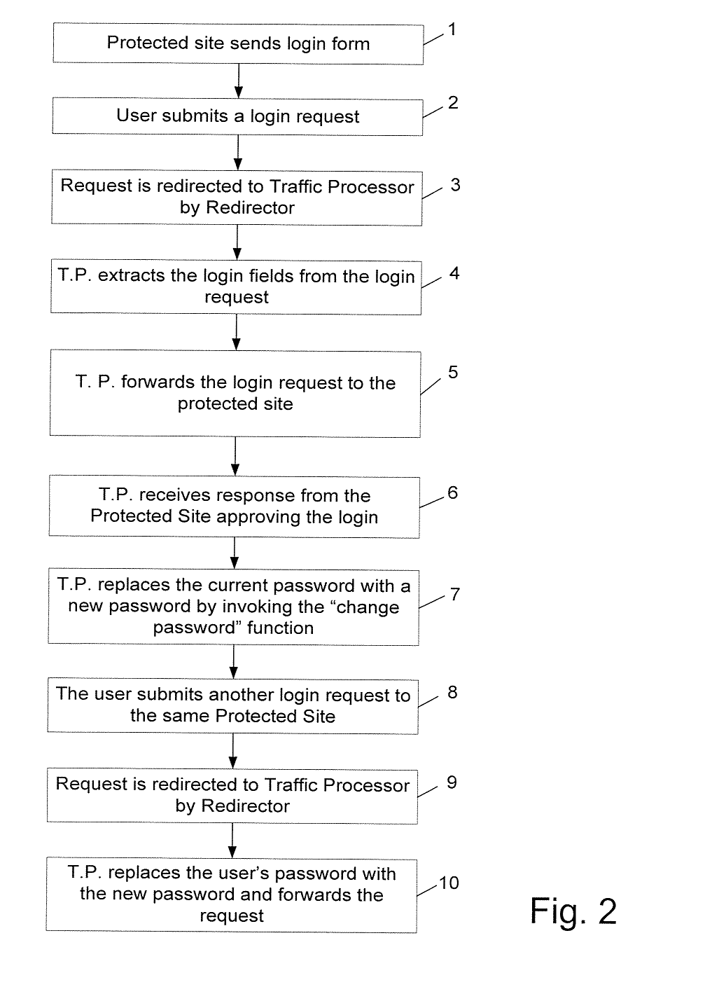

FIG. 2 is a block diagram illustrating the method of the invention according to one of the embodiments. The method is described in relations to FIG. 1. At first the user of client 100 may surf the Network 20 and may visit web server 30 hosting a protected Web site. In step 1 the web server 30 of the protected site sends a login form to the browser 40 of the user for identification. In step 2 the user fills and submits the login request with his login fields in his browser 40, or in other words, the user submits a login request. In step 3 the Redirector 101 detects the browser 40 attempt to transmit the login request to the protected site, and it redirects the request to Traffic Processor (TP) 102. In step 4 the TP 102 detects that this is a login request for a protected site and it copies the login fields from the login request and transfers them to Password Manager 110. In step 5 TP 102 forwards the login request to the protected site. In step 6 the TP 102 receives a response from the protected site approving the login. In step 7, TP 102 obtains from the Password Manager 110 the new corresponding login fields and replaces them in the Server 30 with the original login fields, by invoking the “change password” server function. In some of the cases the Server 30 may request the original login fields before allowing the replacement and, in these cases; TP 102 can obtain the original login fields from Password Manager 110. Thus a login replacement is achieved where the original login of the user is ineffective outside of client 100. In step 8, which may be at a later time, the user wishes to submit another login request to the same protected site. In step 9 the request is once again redirected to TP 102 by redirector 101, where TP 102 detects that the request is to a known protected site. In step 10 TP 102 retrieves the original login fields from the login request and replaces them with the new login fields supplied by Password Manager 110. The new login fields may be calculated each time by a certain hash function, or they may be stored in table 104. The method, as described in relation to steps 8-10 is thus repeated each time the user wishes to log in to the protected site.

In an embodiment of the invention the user is notified before the login is changed, and in another embodiment, permission is also requested from the user prior to changing the login.

In one of the embodiments the user may connect to a number of protected sites in which the method of the invention is applied to each of the sites individually. In an embodiment, the table of the Password Manager may be used to store a number of original logins and their corresponding new logins.

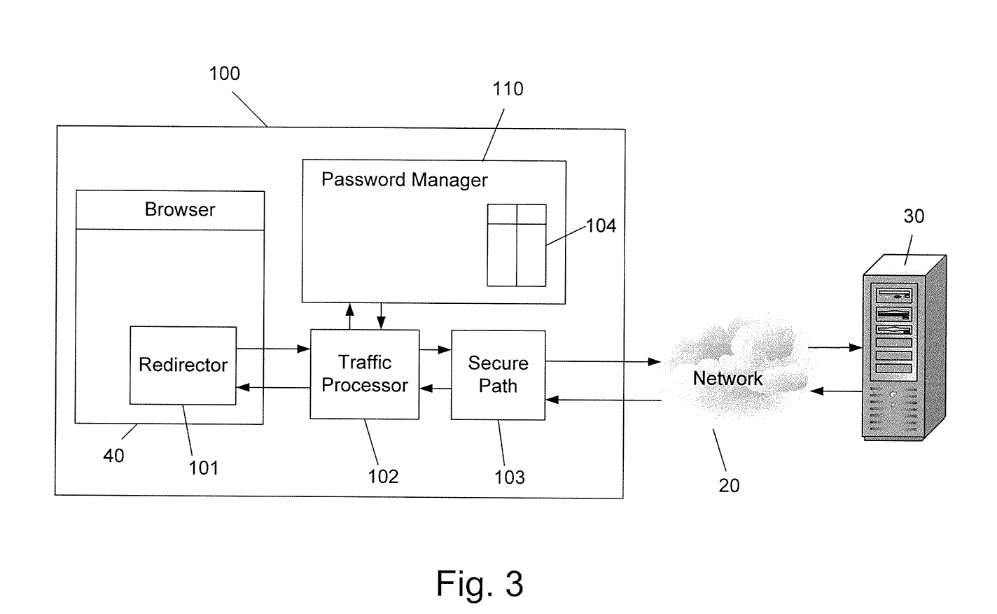

FIG. 3 is a schematic diagram of the system according to another embodiment of the invention. In the diagram client 100 executes a browser 40 when surfing the Network 20 to web server 30. Redirector 101 is a module that forces the browser to avert the traffic transmitted to and from the protected site through TP 102. Redirector 101 can be implemented by a browser plug-in (e.g. BHO) that modifies the URL call to a protected site, e.g. “Rapport://”, together with registering this scheme to the browser as pointing at the Traffic Processor 102. Other myriad ways of implementing this requirement are possible, such as hooking/replacing the existing HTTP and HTTPS protocol handlers, or hooking into a lower level protocol API such as Windows' WinInet. The browser 40 “initiates” the HTTP/HTTPS requests, but it typically delegates the actual handling to lower-level libraries/modules such as Winlnet and/or protocol handlers. A preferred Redirector 101 implementation is therefore to interject in the flow of data from the browser 40 to the lower-level libraries and redirect the traffic to the TP 102. The main role of TP 102 is to replace the login fields provided by the user with new login fields. In this embodiment, Secure Path 103, is added to the process for securing the sending of the new login fields. Secure Path 103 is essentially a stand-alone HTTP+SSL protocol stack. The Secure Path 103 enables the TP 102 to issue any HTTP/HTTPS request, requiring only TCP/IP services from the operating system. By incorporating the close-set and tightly integrated HTTP+SSL stack of secure path 103, TP 102 guarantees that no adversary activity can take place in the dispatching phase, i.e. once the logical request has been prepared, and before it is fully encrypted. The Secure Path 103 may be implemented by means of using open source libraries such as OpenSSL and cURL. Traffic Processor 102 implements most of the logic, meaning that it monitors HTTP traffic and can manipulate HTTP requests and HTTP responses (including monitoring and manipulating the HTML pages), in order to replace the original login fields with the new login fields.

In one of the embodiments, the new login fields are realized either by applying a deterministic function to the original login fields (in some cases together with other parameters such as a machine-specific secret key), or by generating an effective login in possibly a non-algorithmic manner, e.g. by obtaining a random string, and keeping a table that maps the original login to the corresponding new login. The password manager may need to apply additional logic in order to ascertain that the new login meets the password criteria of the protected site for which it is generated. This may include length limit, character set limits, minimum requirements for entropy (non-word, uppercase/lowercase/non-alphanumeric combinations), different from the user name and different from previous N passwords.

Since many web sites encourage and even force users to periodically change their login fields, the method of the invention may be used in this process as well. When a change login form for a protected site is displayed at the browser, the user types his original login with a new user defined login, and submits the request. The browser prepares the HTTP request for changing the login. The Redirector detects that this request is for a protected site and routes the request to the Traffic Processor. The Traffic Processor detects that this request is a change login request and it extracts the original login fields from the login request. Since the corresponding login fields for this site can only be found by the Password Manager, the Traffic Processor fetches the corresponding login fields from the Password Manager and replaces the original login fields in the request with the corresponding login fields. At this point the Traffic Processor may also request new corresponding login fields, from the Password Manager, corresponding to the new user defined login fields supplied by the user. The new corresponding login fields, supplied by the Password Manager, are thus sent in the request with the old corresponding login fields. The request then proceeds to the protected site (possibly using the Secure Path), and the response is forwarded back to the browser.

In another embodiment, the method of the invention may be used for changing password periodically without requiring the user's intervention. The changing of the password may be done in regular intervals predefined by the user or in response to a request from the web site. In this embodiment the TP obtains from the Password Manager the new corresponding login fields and replaces them in the Server of the web site with the original login fields, by invoking the “change password” server function.

In one of the embodiments it may be desirable for the user to obtain the “veiled”, i.e. concealed, corresponding login fields, especially if the user wants to log in from a different computer. This can be achieved in several fashions: (1) by providing the user with the login fields from the Password Manager. The user may ask to be provided with the login fields. Naturally this should be implemented securely to avoid malicious software from obtaining the login fields. (2) When the user indicates that he wants to unveil the login fields (again, such indication must be provided in a secure manner to avoid being fooled by malicious software), the user is redirected to the change login page of the website, in which the user chooses new login fields. In this mode, the new login fields are not replaced by the system of the invention. (3) When the user indicates that he wishes to unveil the login fields (again, such indication must be provided in a secure manner to avoid being fooled by malicious software), the user is presented with a “change login” interface, e.g. a dialog box, produced by the system, in which the user chooses the new login. The system then invokes the site's “change login” function with the old corresponding login and changes the login fields to the new user defined login.

In an example, the invention may be used in any client Server relationship, where the client and the server are communicating over the Internet or any other type of network. For instance, in the RLOGIN protocol (RFC 1258—http://tools.ietf.org/html/rfc1258), the first request contains the username and password, where the Redirector intercepts this data and forwards it to the Traffic Processor. The latter forwards the request to the server, and receives the positive response, meaning that the login established. The Traffic Processor then sends a “change password” request to the server, in UNIX, this is achieved via the password command followed by the old password and the new password, in Windows this is achieved likewise using the NET USER command. The new password specified is obtained from the Password Manager. The Traffic Processor returns the control to the RLOGIN client only after the password has been changed. Later, when a new RLOGIN session is established, the Redirector intercepts the first login request, and changes the password to the one provided by the Password Manager, so the actual login is carried out using the password from the Password Manager. The user continues normally without being affected by the password changing activity which is transparent to him.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. A method for rendering a login theft ineffective comprising the steps of:
a. detecting a submission of a first login request from the user's client to a Web site;
b. redirecting said first login request to the traffic processor for copying at least one of the user supplied login fields;
c. forwarding said first login request from said traffic processor to said site;
d. requesting replacements of at least one of said user supplied login fields from said site; and
e. replacing said at least one of user supplied login fields with at least one new corresponding login field(s) in said site.

2. A method according to claim 1, further comprising the steps of:
f. detecting a second login request intended for the Web site;
g. redirecting said second request to the traffic processor by the redirector;
h. replacing the user supplied login field(s) with the new corresponding login field(s); and
i. forwarding the modified second login request to said site.

3. A method according to claim 1 where the user supplied login fields and new corresponding login fields are stored in a table.

4. A method according to claim 1 where the forwarding of the request(s) by the traffic processor and the receiving of response(s) from the site is done using a secure path.

5. A method according to claim 1 where the user is notified before the user supplied login fields are replaced with new corresponding login fields.

6. A method according to claim 5 where permission is requested from the user prior to replacing the user supplied login fields with new corresponding login fields.

7. A method according to claim 1 where the new corresponding login fields are produced by applying a deterministic function to the original login fields.

8. A method according to claim 3 where the new corresponding login fields are produced by applying a non-algorithmic function.

9. A method according to claim 1, where the user may obtain the new corresponding login fields.

10. A method for rendering a login theft ineffective comprising the steps of:
a. detecting a submission of a first login request from a client to a Server;
b. redirecting said first login request to the traffic processor for copying at least one of the user supplied login fields;
c. forwarding said first login request from said traffic processor to said Server;
d. requesting replacements of at least one of said user supplied login fields from said Server; and
e. replacing said at least one of user supplied login fields with at least one new corresponding login field(s) in said Server.
